(19) United States
(12) Patent Application Publication
(10) Pub. No.: US 2016/0301953 A1
(43) Pub. Date: Oct. 13, 2016

(54) SYSTEMS AND METHODS FOR EXTRACTING DATA FROM AUDIOVISUAL CONTENT

(71) Applicant: EchoStar Technologies L.L.C., Englewood, CO (US)

(72) Inventors: Carlos Garcia Navarro, Boulder, CO (US); Swapnil Anil Tilaye, Westminster, CO (US)

(21) Appl. No.: 14/683,997

(22) Filed: Apr. 10, 2015

(51) Int. Cl. H04N 21/235

(52) U.S. Cl. CPC H04N 21/2353

(57) ABSTRACT

Systems and methods are disclosed that allow a viewer to extract audio and metadata information from an audiovisual content stream to be used with other applications.

### BACKGROUND

1. Technical Field

The present disclosure relates to the field of broadcast entertainment programming, and in particular, to systems and methods for extracting audio and metadata information from an audiovisual content stream to be used with other applications.

2. Description of the Related Art

Audiovisual content providers, such as DISH®, provide entertainment programming to their subscribers through access to multiple channels of live programming and through video-on-demand services. An audiovisual content receiver, for example a set-top box, is required to view the entertainment programming received from audiovisual content providers. The set-top box identifies and verifies the viewer's subscription level to determine the viewer's access to the audiovisual content. Typically, a television display and a speaker system are directly connected to the set-top box. The set-top box, once a subscriber is verified, is able to analyze the available audiovisual content and send video content to the television display for viewing and audio content to the audio system for listening. The audio may include several different tracks, for example audio tracks for multiple foreign languages or one or more voiceover commentaries.

In addition to audio and video content, the audiovisual content stream includes metadata information that provides data about the audio and video content. Metadata information includes information such as program name, series name, synopsis, etc. Metadata information may also include closed-captioned content, in one or more languages, that transcribes dialog and describes scenes that appear in the video content.

### BRIEF SUMMARY

Systems and methods are disclosed for extracting audio data and metadata from audiovisual content and sending the extracted data for use with other applications. This may include sending the extracted data to a device other than a device that is directly connected to the content receiver. For example, a viewer watching a movie may wish to extract metadata information from the received audiovisual content of the movie that includes the movie's name, brief synopsis, and list of principal players, and send that information to a smartphone for viewing while the movie is playing on the television display. The viewer may then use this received information to do further searches, for example using IMDb™ or Google™ to get more information about details of the movie being viewed.

A viewer watching a football game may wish to extract metadata information about the game that includes team names, current score, team statistics, individual player statistics and current and historical statistics for the competing teams; and send that extracted data to the viewer's smartphone in real time. The viewer may also wish to extract closed-captioned content from the audiovisual stream in real time and send it to the viewer's smartphone for viewing.

In another implementation, a viewer may wish to extract audio data from the audiovisual program and send it to the viewer's tablet. This will allow the viewer to watch the video content on the television display and to listen to the corresponding audio using headphones attached to the tablet. In this way the viewer can listen to an audiovisual program in a noisy room or when viewing the program that is far away, when it would be otherwise difficult or impossible to hear the audio from speakers attached to the television display.

For example, a health club with a large exercise room containing multiple treadmills and elliptical machines oriented in different directions may have multiple television displays for their members to view while exercising on the machines. With this disclosure, the health club can enable individual members to use their own smartphones to listen to the audio corresponding to any one of the several displays and to view metadata information corresponding with the video, for example to view closed-captioned information or other information about the viewed program. In this example, there are at least two ways that the audio and metadata information can be extracted from the audiovisual stream. The first is to extract the audio and metadata using a content receiver located at the health club and to make the extracted data available to the devices of individual members. The second is for the member, using a smartphone or other device, to access extracted audio and metadata information through the member's own individual subscription with an audiovisual content provider, while the member watches the video on the health club's display provided by the health club's own audiovisual content subscription. For instance, the health club may be displaying NBC™ Nightly News on one display using the health club's DISH® subscription, and the member will access the audio and metadata associated with NBC™ Nightly News using the member's own DISH® subscription, with the audio and metadata extraction system running on the viewer's smartphone.

Other examples of using these systems and methods include viewers of a television display in a large noisy restaurant or a large family room that use the extraction system to receive subtitles to view on a smartphone; viewers of multiple displays in a business environment to view audio of financial updates and metadata including stock prices and other financial statistics related to companies that are displayed on the screen; or viewers of multiple displays displaying different content throughout a larger structure such as a museum where visitors can listen to the audio and to view metadata information that is relevant to the museum objects in proximity to the video display.

As referred to above, systems and methods of where the data extraction is performed may vary. In one example, a user's set-top box may be used to extract the audio or metadata from the audiovisual stream and then send that extracted data to a device over the Internet or other communications network specified by the user. In another implementation, the user may view video content on a display device and use the user's own separate audiovisual content subscription to receive the audiovisual content stream and to extract the audio or metadata that is related to the displayed video content.

In addition, the display of metadata information may occur in a number of ways, including as text, graphics or video images that appear to be projected out of a display device, appearing to the viewer to be on a visual plane that is different than the plane of the visual display. For example, sports scores and player statistics that are part of the metadata information included in an audiovisual stream of a sports event may appear to be projected out of the television display and appear closer to the viewer than the screen in holographic form. In some examples, the data that is projected out may appear as either two-dimensional or three-dimensional text, graphics or video images.

### BRIEF DESCRIPTION OF THE SEVERAL VIEWS OF THE DRAWINGS

FIG. 1 shows a diagram of one implementation of a system within a content receiver for extracting data from audiovisual content and displaying the extracted data to a user.

FIG. 2 shows a diagram showing multiple implementations of a system for extracting data from audiovisual content and displaying the extracted data to a user.

FIG. 3 shows a diagram of an implementation in a multi-display environment of a system for extracting data from audiovisual content and displaying the extracted data to several users.

FIG. 4 shows a dataflow diagram that describes one implementation of a method for extracting data from audiovisual content and displaying the extracted data.

FIG. 5 shows a dataflow diagram that describes one implementation of a method for receiving extracted audio and metadata information from a subscription service.

FIG. 6 shows a system diagram that describes one implementation of a computing system for implementing systems and methods for extracting data from audiovisual content.

### DETAILED DESCRIPTION

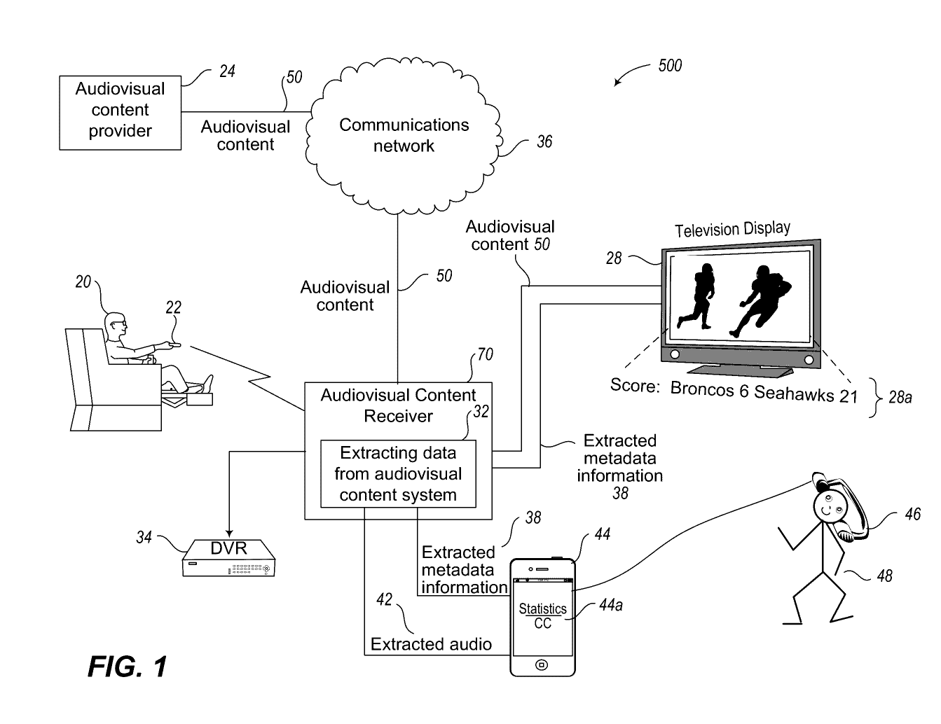

FIG. 1 contains diagram 500 that shows an implementation of a system for extracting audio and metadata information from audiovisual content and displaying the extracted data to a user. In this implementation, a user 20 uses a remote control device 22 to control a audiovisual content receiver 70 that is running an extracting data from audiovisual content system 32. In other implementations, the extracting data from audiovisual content system 32 may be running in a separate receiving device and implemented using either hardware, software or a combination of both, and may be located in proximity to the user's 20 location or at a remote location, for example at a remote server computer.

The audiovisual content receiver 70 is connected to a television display 28 on which the user 20 views the various audiovisual content 50 that is received by the audiovisual content receiver 70 from an audiovisual content provider 24 via a communications network 36. The audiovisual content receiver 70 can be any one of a set-top box, a smartphone, a computer, a tablet, or any other device that can receive and process an audiovisual content stream 50. The communications network 36 may include a number of different communication systems using a variety of protocols, including Internet and private communications protocols used by various content subscription services, for example by DISH®.

The audiovisual content provider 24 may be a content distributor such as DISH® that is part of the subscription service, may be Internet-based providers such as Netflix™, Amazon Prime Video™, Hulu™, Twitch™ and the like, or be over-the-air broadcast providers that distribute content that is received via HD antenna (not shown). The audiovisual content 50 may include live broadcast content over multiple television channels that are received from the audiovisual content provider 24, or may be content that has been recorded by the user 20 on a digital video recorder 34. The digital video recorder 34 may be integrated within the audiovisual content receiver 70, a component that is connected to the audiovisual content receiver 70, or a device or service available remotely to the user 20 through the communications network 36.

Another form of audiovisual content may be video-on-demand content that is available over communications network 36, and may include content such as movies, sports events or series episodes. Video-on-demand content is typically provided through access via a subscription and is available to a user 22 through a user interface that enables the viewer to select desired titles for eventual viewing on the television display 28.

The audiovisual content 50 received from the audiovisual content provider 24 via the communications network 36 includes video content, audio content associated with the video content, and metadata information. The extracting data from audiovisual content system 32 analyzes the audiovisual content stream and produces extracted audio 42 and extracted metadata information 38 that is sent to an audio and metadata display device 44 such as a smartphone, with a display area 44a.

Extracted audio 42 includes the audio content associated with the video content included in the audiovisual content 50. The extracted audio 42 may include one or more of the audiovisual content soundtrack, dialogue in one or more languages, video commentary, and other audio that is related to the video provided by the audiovisual content provider 24. Extracted audio 42 may be sent to an audio and metadata display device 44 to be presented auditorily to a viewer 48 over headphones 46 while viewing the television display 28.

The extracted metadata information 38 includes information related to one of or to both the video and audio content of the audiovisual content 50. Examples of extracted metadata information 38 include the name of the program or title of the movie being displayed; the series name and the series episode identification; content synopsis; a cast list of characters and performers in the content; closed-captioning text content; references to Internet uniform resource locators for additional information related to content that is being currently displayed; encoded images; encoded video clips and the like.

Preferably, the extracted audio 42 and extracted metadata information 38 is sent to a device such as a smartphone 44 in real time or in substantially real time so that the extracted data can be presented in a way that is synchronized with the displayed video content. However, in some implementations this extracted information may be provided in an asynchronous manner.

In one implementation, the extracted audio 42 and extracted metadata information 38 may be sent to a device such as a smartphone 44, for presentation or interaction with a smartphone user 48. In some variations of the implementation, the extracted metadata information 38 may be analyzed and processed by an application on the smartphone 44 and presented to the user 48 on the smartphone display 44a. This displayed information may include statistics of the game that the smartphone user 48 is watching on display 28, closed captioning for a movie being watched on display 28, or other information about the video being displayed on display 28 that may be searched using other applications on the smartphone 44 such as IMDb™ or Google™. In addition, extracted metadata information 38 that appears in text form may be converted to audio and played auditorily through the smartphone 44 to listener 48 through headphones 46.

The extracted metadata information 38 may also be presented on a television display 28. In some implementations, in addition to the display 28 playing the audiovisual content 50 received from the audiovisual content receiver 70, extracted metadata information 38 can be sent and displayed in a holographic form 28a on the television display 28. In these implementations, metadata information such as a game score or other information as described above will be projected out of the television display 28 and appear in a visual plane that is different than the plane of the display 28. This information may be projected out in either a two-dimensional or three-dimensional projection while the video content of the game will continue to be presented on the display 28.

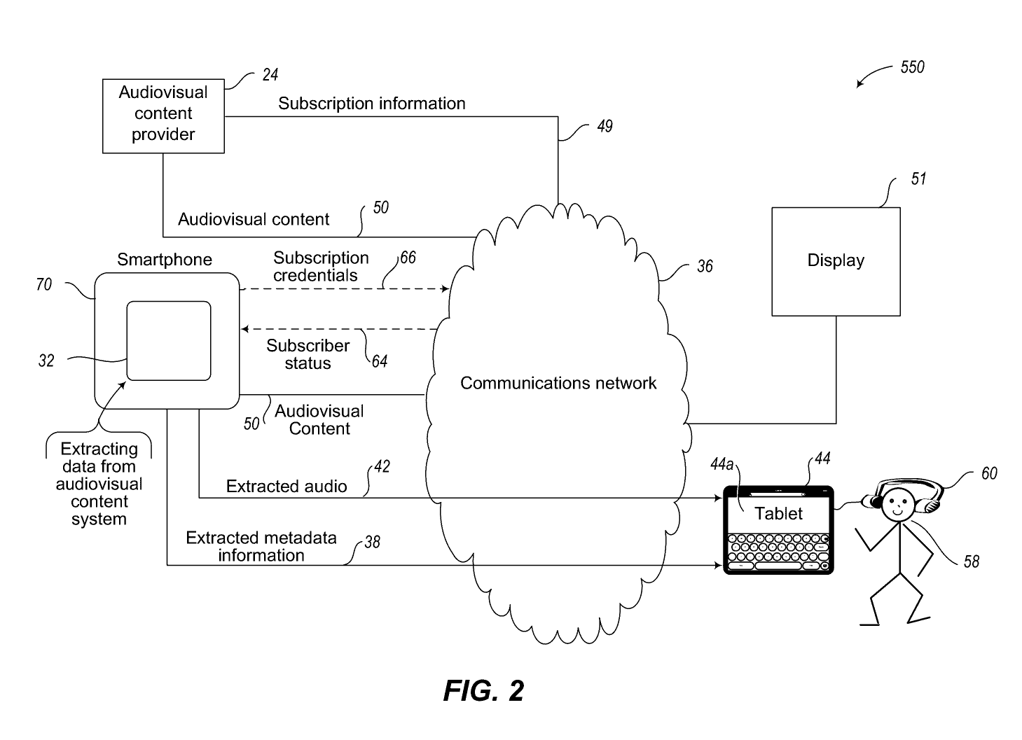

FIG. 2 shows diagram 550 that shows another implementation of a system for extracting data from video content and displaying extracted data to a user. In this implementation, an audiovisual content receiver 70 is running an extracting data from audiovisual content system 32, which is used to extract audio 42 and extract metadata information 38 for use with an audio and metadata display device 44, such as a tablet. Other examples of an audiovisual and metadata display device may include a smartphone, personal computer, iPod™, iPad™′ other tablet device, smartwatch, Google Glass™ and the like.

The audiovisual content receiver 70 connects with audiovisual content provider 24 through communication network 36 to exchange subscription information 49 with content provider 24 to determine the type of audiovisual content 50 to which the audiovisual content receiver 70 has access. In one variation of the implementation, the audiovisual content receiver 70 sends subscription credentials 66, for example information regarding a personal subscription, to the audiovisual content provider 24 requesting audiovisual content 50, and in return receives a subscriber status 64 that identifies if the audiovisual content receiver 70 has access to the requested audiovisual content 50. If the audiovisual content receiver 70 has access to the requested content, then the audiovisual content 50 is delivered to the audiovisual content receiver 70 by the audiovisual content provider 24. In another variation, a subscription for the requested content may be purchased via the audiovisual content receiver 70 from audiovisual content provider 24 and the audiovisual content receiver 70 subsequently receives audiovisual content 50, for example by purchasing a full subscription that includes the requested content or by purchasing the requested content on a pay-per-view basis.

The audiovisual content receiver 70 receives the audiovisual content 50, which includes audio and metadata information, via the communications network 36. The extracting data from audiovisual content system 32 application running on the audiovisual content receiver 70 processes the received audiovisual content and creates extracted audio 42 and extracted metadata information 38.

In another variation of the implementation, the extracted audio 42 and extracted metadata information 38 are sent via communications network 36 to an audio and metadata display device 44, such as a tablet, where the extracted metadata information 38 is presented for display to a mobile user 58, and extracted audio 42 is presented to the mobile user 58 over headphones 60. The video portion of the audiovisual content 50 may be displayed on the audio and metadata display device display 44a.

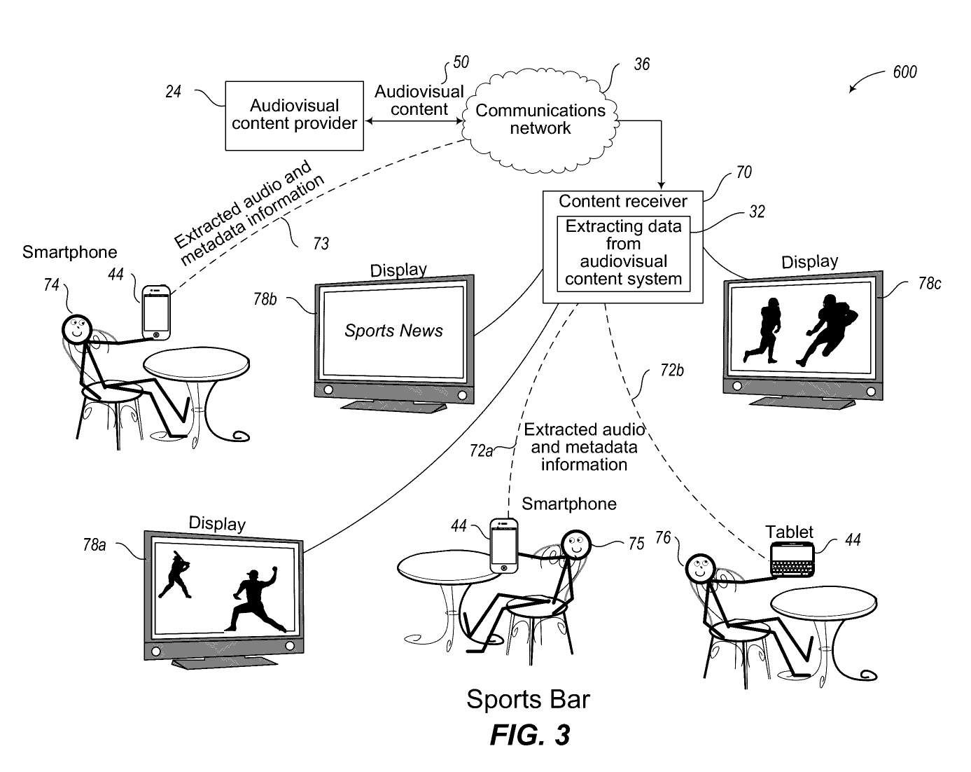

FIG. 3 shows diagram 600 which is an example implementation of a system for extracting data from audiovisual content and displaying the extracted data to several users in a multi-display sports bar environment. The sports bar has several displays 78a, 78b, 78c that are viewed by multiple viewers 74, 75, 76, each viewer having a personal device with a display and audio capability. Variations of this implementation also apply to other environments such as the health club implementation discussed above.

The audiovisual content provider 24 provides audiovisual content 50 through a communications network 36 to an audiovisual content receiver 70 located at the sports bar. The audiovisual content receiver 70 receives audiovisual content for multiple channels and displays the video for these different channels simultaneously on different displays 78a, 78b, 78c. This gives each of the viewers 74, 75, 76 an opportunity to view the display showing the programming that each wishes to view, for example a football game, a baseball game, or a sports news program.

In this environment, it is likely very noisy and would be difficult for each of the individual viewers 74, 75, 76 to listen to the audio for each channel, particularly if the audio for the channels running on all of the displays 78a, 78b, 78c are playing at the same time from the displays' speakers. In addition, although the audiovisual content receiver 70 may send closed-captioning information on the displays so that viewers can understand the audio associated with the video on the screen, there may be other metadata information that viewers may wish to be aware of and use to enhance their experience of viewing the content by using their personal devices.

This implementation shows two variations of extracting data from audiovisual content and providing the extracted audio and metadata information to viewers. In the first implementation, the users 75 and 76 are receiving extracted audio and metadata information from the extracting data from audiovisual content system 32 that is part of audiovisual content receiver 70. In this variation, multiple channels that are received from the audiovisual content provider 24 are processed by the audiovisual content receiver 70, and selected video content showing the desired video programming is displayed on each display 78a, 78b and 78c. In this example, a baseball game is playing on a first display 78a, a football game is playing on a second display 78c and a sports news program is playing on a third display 78b.

The viewer 75 indicates an interest in watching baseball content on the display 78a by using the user's audio and metadata display device 44, here a smartphone, to connect with the extracting data from audiovisual content system 32 to receive extracted audio and metadata information 72a associated with the displayed baseball content on the first display 78a. This extracted information will be available as audio that can be listened to by user 75 from the audio and metadata display device 44, for example by holding the device close to the user's 75 ear or by attaching an earpiece or headphones (not shown) to the audio and metadata display device 44. Received metadata information may be analyzed by the audio and metadata display device 44 and be made available to the viewer 75 to enhance the experience of watching the baseball content, for example by retrieving from the metadata information the name of the current batter and displaying statistics of the batter's performance on the audio and metadata display device 44.

Similarly, viewer 76 is watching a football game on a second display 78c using an audio and metadata display device 44, here a tablet, to connect to the extracting data from audiovisual content system 32 to receive extracted audio and metadata information 72b associated with the football game video content presented on the display 78c.

In the second implementation, the user 74 is watching a sports news show on a third display 78b. Although the video for the display 78b is coming from the audiovisual content receiver 70, the audio and metadata information associated with the sports news show is coming from another source via the communications network 36 and not from the audiovisual content receiver 70 or its associated extracting data for audiovisual content system 32. The viewer 74 uses the audio and metadata display device 44, here a smartphone, to directly contact an audiovisual content provider 24 to receive the same audiovisual content 73 that matches the video presented on the display 78b. The display 78b may be displaying ESPN™ SportsCenter using the sports bar's DISH® subscription, and the viewer 74 will access the audio and metadata information associated with ESPN™ SportsCenter using the member's own DISH® subscription.

The user 74 may have a subscription to access the content from the audiovisual content provider 24, or may have purchased the specific audiovisual content as a pay-per-view subscription. In this example, the audio and metadata display device 44, here a smartphone, could be providing the function of extracting data from the audiovisual content system, or the audio and metadata display device 44 could be receiving extracted audio and metadata information 73 from an extracting data from audiovisual content system service (not shown) located remotely from the sports bar and available via the communications network 36.

Once the extracted audio and metadata information 73 is available at the audio and metadata display device 44, the user 74 can listen to the audio and/or view the metadata information in the way the user 74 prefers, to enhance the experience of viewing the sports news program on the display 78b.

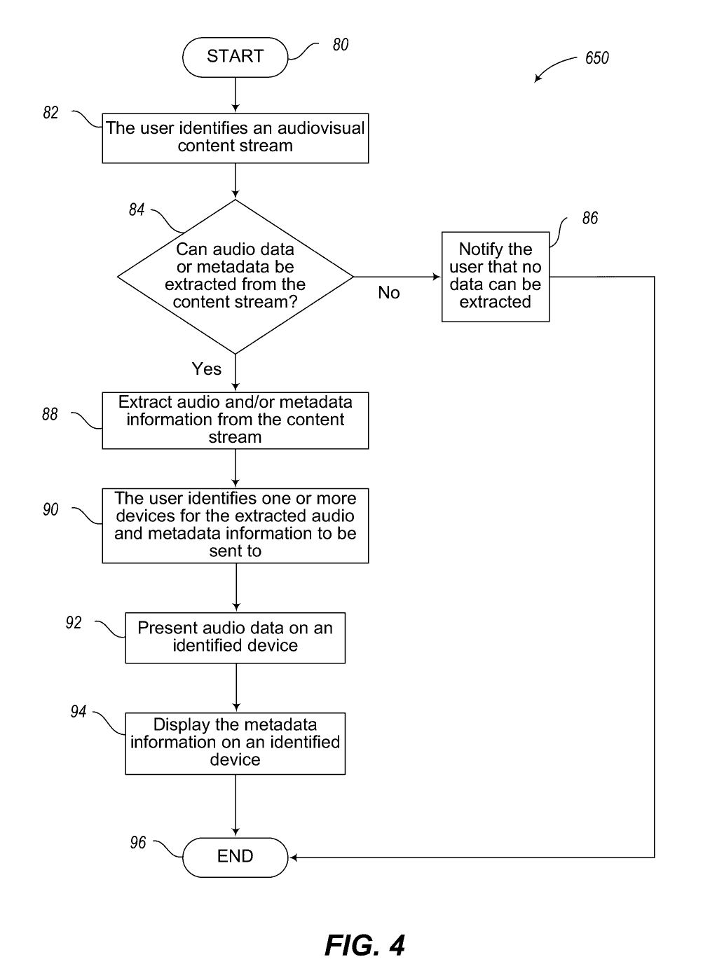

FIG. 4 shows flow diagram 650 which describes one implementation of a method for extracting data from video content and displaying the extracted data. At step 80, the method starts.

At step 82, the user identifies an audiovisual content stream. This identification may, for example, be accomplished as shown in FIG. 1 by user 20 using remote control 22 to select a channel on an audiovisual content receiver 70 for display on television display 28. In another example, as shown in FIG. 3, viewers 75, 76 would use audio and metadata display devices 44 to indicate to the extracting data from audiovisual content system 32 the display that is being viewed in order to identify the sources from where the audiovisual content stream may be located.

At step 84, the method determines if audio data or metadata can be extracted from the content stream. If it cannot, then at step 86 the user is notified that no data can be extracted and the method ends at 96.

At step 88, the method extracts audio and/or metadata from the content stream. In one or more implementations this extraction involves analysis of the audiovisual content stream to determine related audio and metadata information that may be extracted from the stream. Audio data includes primary audio, secondary audio programming and other audio data including but not limited to dialog, music scores, and commentary that is included in the audiovisual content stream. Metadata information includes but is not limited to closed-captioning, title and other information about the program displayed such as cast members, teams and current scores if the program is a sports program, graphics, embedded video content represented as metadata and the like. In this step, the metadata information may be analyzed as well which may include, but is not limited to, parsing closed-captioning text to identify the type of the program (e.g., movie, series, sports event) that is being watched; if the program is a movie or a series, identifying the title of the movie, the director, the cast, location information and the like; if the program is a sports program, identifying the teams that are playing, team statistics, the current score, the players on the field, player statistics and the like; and the identification of any other related metadata information. In addition, this step may include translating closed-captioning information into audio information, for example by using a text-to-speech program, to create an audio stream that can be presented to the user. In some implementations this step may also include additional analysis done on the metadata information, for example searching for sports statistics for players in third-party sports databases and searching for movie or cast information in the IMDb™ database.

At step 90, the method has a user identify one or more devices for the extracted audio and extracted metadata information to be sent to. These devices may include smartphones, tablets, personal computers and the like. An indication of these devices can come from a number of sources including but not limited to user input at the audiovisual content receiver 70; pairing the device with an audiovisual content receiver 70 using Bluetooth, infrared, Wi-Fi or similar pairing technologies used to create a coupled connection with the device; user input at the desired device to create the connection; and querying a user preference database 238 that identifies the devices to which the extracted information should be sent.

At step 92 the method will present the audio data on an identified device—for example, by playing the audio data on the speaker of the smartphone or through headphones connected to the smartphone.

At step 94, the method will display the metadata information on an identified device. This includes, but is not limited to, presenting game score information or presenting closed-captioning text on the tablet screen; or presenting analyzed metadata information on a display so that it is projected holographically out of the display and viewed on a different plane than the images on the screen; or presenting text metadata as either embedded images or videos; or auditorily presenting metadata information that has been converted to audio.

At step 96, the method ends.

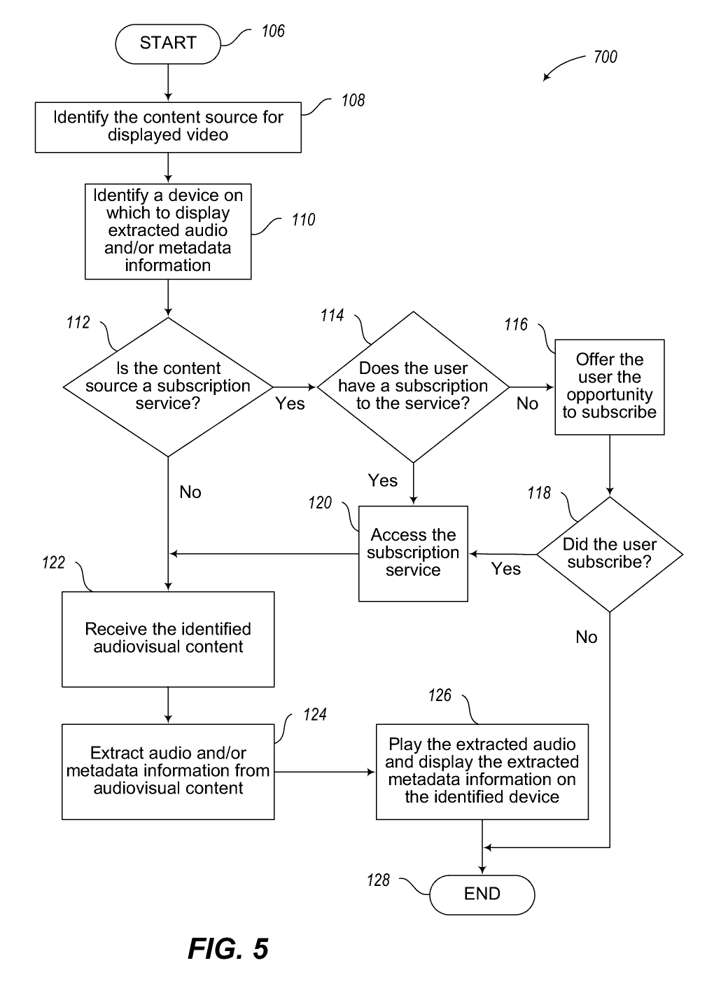

FIG. 5 shows flow diagram 700 which describes one implementation of a method for extracting and receiving audio and metadata from a subscription service. At 106, the method starts.

At step 108, the method identifies the content source for displayed video. Typically, this identification is received from a user who has identified the program that is streaming live on a display device, and is able to identify the source. In other implementations, this information may be stored in a table within a user preference database 238 or may be provided by the audiovisual content receiver 70, or by another system that is able to identify the source of the displayed video. For example, a user in a health club with multiple treadmills and multiple television displays wants to listen to the audio and view metadata for video content being shown on a display that is in front of the treadmill. The user identifies the video content that is being displayed as the NBC Nightly News™. The user may recognize that the user's subscription to DISH® includes access to a channel that provides this program.

At step 110, the method receives from the user an identification of a device on which to display extracted audio and/or metadata. For example, the identified device could be a smartphone or a tablet that is personal to the user and is able to receive extracted audio and metadata information through a Bluetooth or Wi-Fi connection.

At step 112, the method determines if the content source is a subscription service. In particular, if the content source identified in step 108 is part of a subscription service that is available to the user. If so, then at step 114, the method determines whether the user has a subscription to the service; for example, if the user has a subscription to DISH® that has access to a channel that displays the news program. If the user does not have a subscription to the service, then at step 116 the method offers the user the opportunity to subscribe. This step may also include the option to sign up for an ongoing subscription with the audiovisual content provider 24, or to purchase the content from the audiovisual content provider 24 in a pay-per-view format. At step 118, the method determines if the user has subscribed to the subscription service to receive the desired content. If not, then the method ends at 128.

If the user is subscribed, then at step 120 the method will access the subscription service.

At step 122, the method will receive the identified audiovisual content.

At step 124, the method will extract audio and metadata information from the audiovisual content. This may be performed as described above for FIG. 4.

At step 126, the method will play the extracted audio and display the extracted metadata information on the identified device. This may be performed on the identified device in a manner as described above for FIG. 4.

The method ends at 128.

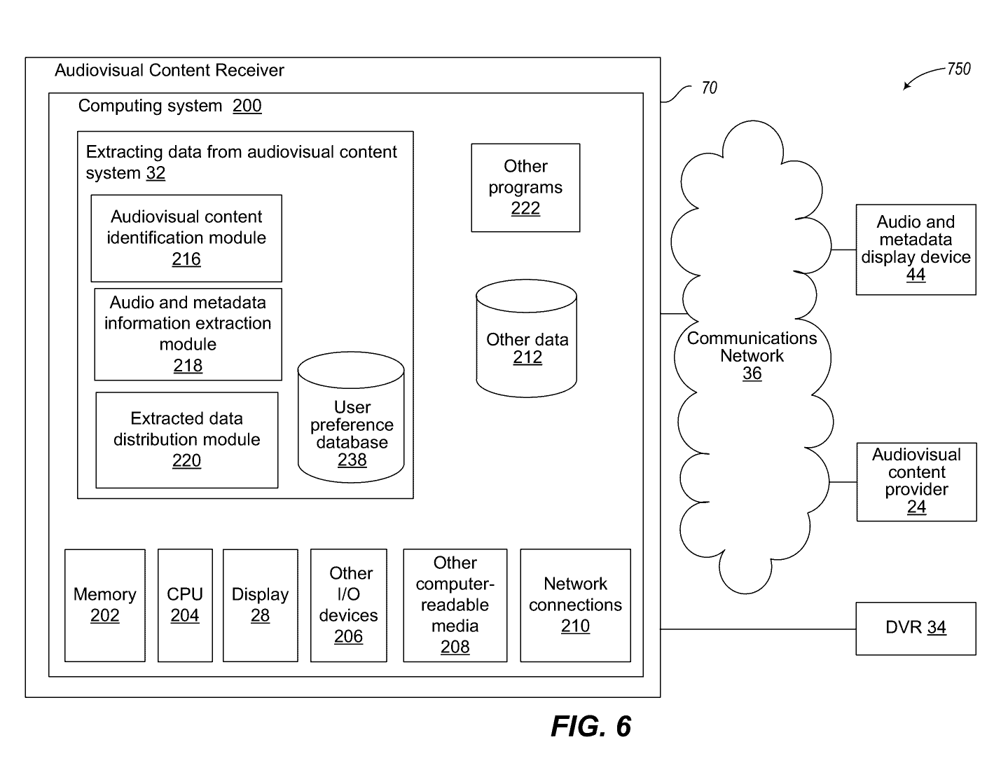

FIG. 6 shows diagram 750 of one implementation of a computing system for implementing systems and methods for extracting data from audiovisual content. FIG. 6 includes a computing system 200 within an audiovisual content receiver 70 that may be utilized to implement an extracting data from audiovisual content system 32 with features and functions as described above. One or more general-purpose or special-purpose computing systems may be used to implement the extracting data from audiovisual content system 32. More specifically, the computing system 200 may include one or more distinct computing systems present having distributed locations, such as within an audiovisual content receiver 70 that may be implemented within a set-top box, personal computing device, smartphone or tablet. In addition, each block shown may represent one or more such blocks as appropriate to a specific embodiment, or may be combined with other blocks. Moreover, the various blocks of the extracting data from audiovisual content system 32 may physically reside on one or more machines, which may use standard inter-process communication mechanisms (e.g., TCP/IP) to communicate with each other. Further, the extracting data from audiovisual content system 32 may be implemented in software, hardware, and firmware or in some combination to achieve the capabilities described herein.

In the embodiment shown, computing system 200 includes a computer memory 202, a display 28, one or more Central Processing Units (“CPUs”) 204, input/output devices 206 (e.g., keyboard, mouse, joystick, track pad, LCD display, smartphone display, tablet and the like), other computer-readable media 208 and network connections 210 (e.g., Internet network connections or connections to audiovisual content distributors). In other embodiments, some portion of the contents of some or all of the components of the extracting data from audiovisual content system 32 may be stored on and/or transmitted over other computer-readable media 208 or over network connections 210. The components of the extracting data from audiovisual content system 32 preferably execute on one or more CPUs 204 to facilitate the identification of an audiovisual content stream, extract related audio and metadata information from the stream, and to distribute the extracted data to one or more identified devices for playing or viewing. Other code or programs 222 (e.g., a Web server, a database management system, and the like), and potentially one or more other data repositories 212, also reside in the computing system 200, and preferably execute on one or more CPUs 204. Not all of the components in FIG. 6 are required for each implementation. For example, some embodiments embedded in other software do not provide means for user input, for display, for a customer computing system, or other components, such as, for example, an audiovisual content receiver 70 or other receiving device receiving audiovisual content from an audiovisual content provider 24.

In a typical embodiment, the extracting data from audiovisual content system 32 includes an audiovisual content identification module 216, an audio and metadata information extraction module 218, and an extracted data distribution module 220.

Audiovisual broadcast content is received from an audiovisual content provider 24, which may be provided via a communications network 36. In one or more implementations, the audiovisual content identification module is used to identify the audiovisual content in which the user 20 is interested. The audio and metadata information extraction module 218 analyzes the identified audiovisual content and extracts audio and metadata information related to the audio and video for use in other applications. This extracted data is distributed using the extracted data distribution module 220, including distribution to user identified audio and metadata display devices 44, such as a smartphone or a tablet, on which the extracted audio or extracted metadata information can be displayed in a number of different ways, including but not limited to those ways as described above.

Other and/or different modules may be implemented. The extracting data from audiovisual content system 32 also, in some implementations, contains the user preference database 238, which includes information about preferred devices to which the user wishes extracted audio and metadata information to be sent.

The audiovisual content identification module 216 performs at least some of the functions as described with reference to FIGS. 1-5. In particular, the audiovisual content identification module 216 identifies the audiovisual content from which a user 20 wishes to extract audio and metadata information. The video portion of the audiovisual content is typically displayed on a television display 28 or some other display device. However, in some implementations video is not displayed and the audio and metadata information related to the audiovisual content may be extracted and used, for example, to only listen and to view metadata information related to selected audiovisual content of a symphony performance or sporting event.

The audiovisual content may include, but is not limited to, channels of a satellite broadcasting system such as DISH® that stream live content over many hundreds of channels to subscribers through audiovisual content receivers 70. The audiovisual content may also be from subscription services such as Netflix™, Amazon Prime Video™, Hulu™, Twitch™ and the like, from non-subscription services such as YouTube™, or from pay-per-view services. The audiovisual content may also be content that has been recorded by the user 20 on a digital video recorder 34 and replayed on a display 28.

In one implementation, the audiovisual content identification module 216 interacts with the user 20 during the selection process as audiovisual content, such as a television channel, is selected for display on a television display 28. The selection will identify the audiovisual content from which the user 20 wishes to extract the audio and metadata information. This extracted audio and metadata information will be eventually sent to an audio and metadata display device 44, for example a smartphone, for presentation to the user 20. As described above, the user 20 is able to use a number of different methods to select the audiovisual content and sources. In one implementation, the user 20 may use remote control 22 to instruct an audiovisual content receiver 70 to select a particular channel.

In another implementation, an application on the user's audio and metadata display device 44, for example a smartphone, may identify the audiovisual content that is being displayed on one of several displays within a large area such as a sports bar as described in FIG. 3. In one variation, an application on a smartphone may capture either the video or audio being displayed on another display, analyze the captured information and from that analysis determine the audiovisual content. The application may then identify on which audiovisual content sources (e.g., DISH® channel) the audiovisual content may be found. In some variations, the content may be provided via a paid or subscription-based content source. Alternatively, the user 20 may visually recognize the audiovisual program being displayed and identify the source of the audiovisual content.

The audio and metadata information extraction module 218 performs at least some of the functions as described with reference to FIGS. 1-3 and 5. In particular, the audio and metadata information extraction module analyzes the identified audiovisual content stream and extracts audio data and metadata related to the audio and video content within the stream. Examples of extracted audio include the default soundtrack of the audiovisual program, the secondary audio program that is typically in a different language than the default soundtrack, and audio commentary, for example a director's commentary of a movie. Examples of extracted metadata information include closed-captioned content in one or more languages, or information about the program, such as the program title, synopsis, cast, and related descriptions of the program. For sports programs, metadata information may include team names, current scores during the game and statistics for players that are on the field. Audio and related metadata information that is extracted from the audiovisual content may be converted into various streaming formats to be delivered to audio and metadata display devices 44 for presentation to the user 20.

The extracted data distribution module 220 performs at least some of the functions as described with reference to FIGS. 1-5. In particular, the extracted data distribution module 220 receives an identification of one or more audio and metadata display devices 44 to which extracted audio and related metadata information should be sent. In one or more implementations, the user 20 may identify one or more devices by querying the user preference database 238. Audio and metadata information is then sent to the identified devices. In some implementations, once the data is sent to an audio and metadata display device 44, for example a smartphone, applications on the smartphone may further analyze the information, interacting for example with third-party databases to acquire information related to the metadata that would be relevant for a user; for example, receiving metadata information that includes the director of a series episode and querying the IMDb™ database to present more information about the director to the user 20.

In one or more implementations, the extracted data distribution module 220 will indicate how the audio and metadata information is displayed on a display device. For example, metadata information may be analyzed, formatted, and sent to the indicated device with instructions to display the metadata in a certain way. For example, in some variations of implementations, metadata information such as the current score of a sports program may be displayed on a display device 28 in a holographic form, so that the metadata appears to be “projected out” of the screen. In other implementations, the audio and metadata display device 44, for example a smartphone or tablet, may contain an extracted data distribution module 220 on the device that will play the audio and display metadata in a way that is optimized for that device according to user 20 preferences in the user preference database 238, or optimized for other display characteristics available for features found in that device.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A system for extracting data from an audiovisual content stream comprising:
an audiovisual content receiver;
a processor within the audiovisual content receiver;
a non-transitory computer-readable memory communicatively coupled to the processor, the memory storing computer-executable instructions that, when executed, cause the processor to:
receive, from an audiovisual content provider, a plurality of audiovisual content streams, each audiovisual content stream of the plurality of audiovisual content streams including a respective video stream of a plurality of video streams and a respective audio stream of a plurality of audio streams;
send the plurality of video streams to one or more displays to be displayed simultaneously;
receive, from a first user, a selection of a displayed video stream of the plurality of displayed video streams, the displayed video stream being included in an audiovisual content stream;
route the audiovisual content stream to an extraction module;
extract, from the audiovisual content stream, data including both the respective audio stream of the audiovisual content stream and metadata information for both the audio stream and the video stream of the audiovisual content stream;
receive, from the first user, an indication of a device external to the audiovisual content receiver to send the extracted data; and
send the extracted data to the indicated external device.

2. The system of claim 1, wherein the audio stream and the metadata information have different distribution paths than a distribution path of the video stream.

3. The system of claim 1, wherein the device external to the audiovisual content receiver is one of a smartphone, a tablet, a personal computer, a smartwatch, an iPod, an iPad, and Google Glass.

4. The system of claim 1, wherein sending the extracted data to the indicated external device further includes sending the extracted data to the indicated external device via a communications network.

5. The system of claim 1, wherein the indicated external device is a television connected to the audiovisual content receiver, the television being able to project holographic images; and
wherein sending the extracted data to the indicated external device further includes sending to the television the extracted data along with commands to display the data on the television using holographic images.

6. A method for receiving data at a smartphone comprising:
sending, to an audiovisual content provider, an indication of an audiovisual content stream of a plurality of audiovisual content streams respectively associated with a corresponding plurality of video data and audio data that is matched with the video data, the plurality of video data being simultaneously displayed on one or more displays connected to the audiovisual content provider, the indication of the audiovisual content stream of the plurality of audiovisual content streams being sent in connection with a request to receive, at the smartphone, data related to the audiovisual content stream of the plurality of audiovisual content streams, the data including both audio that relates to the video data and metadata information for both audio and video data of the indicated audiovisual content stream;
in response to sending the indication of the audiovisual content stream, receiving, from the audiovisual content provider, the audio that relates to the video data and metadata information for both the audio and video data of the indicated audiovisual content stream;
upon receiving the metadata, analyzing the received metadata; and
presenting, on the smartphone, the received audio data and analyzed metadata.

7. The method of claim 6, wherein the audio data and metadata information have different distribution paths than a distribution path of the video data.

8. The method of claim 6, wherein presenting the analyzed metadata further includes:
converting closed-captioned text within the analyzed metadata to audio, and
presenting the converted audio on the smartphone.

9. The method of claim 6, wherein the metadata information is one of sports scores, closed-captioned text, program title, program synopsis and cast list.

10. The method of claim 6, further comprising after sending the indication of the audiovisual content stream:
determining, by the audiovisual content provider, whether a user has permission to access the indicated audiovisual content stream;
if the user does not have permission to access the indicated audiovisual content stream, offering a content subscription to the user to allow access to the indicated audiovisual content stream.

11. The method of claim 10, wherein offering a content subscription to the user includes one of:
offering a pay-per-view content subscription to the user to allow access to only the indicated audiovisual content stream, and
offering a general content subscription to the user to allow access to at least the indicated audiovisual content stream.

12. The method of claim 10, wherein determining whether the user has permission to access the indicated audiovisual content stream further includes determining whether the user has a subscription to access the indicated audiovisual content stream.

13. A method for receiving audio and metadata related to an audiovisual content stream comprising:
receiving, from an audiovisual content provider, a plurality of audiovisual content streams each audiovisual content stream including a respective video data of a plurality of video data and a respective audio data of a plurality of audio data that is matched with the video data;
sending the plurality of video streams to one or more displays to be displayed simultaneously;
at a time when the plurality of video streams are simultaneously displayed, receiving a selection of an audiovisual content stream of the plurality of audiovisual content streams;
routing the selected audiovisual content stream to an extraction module;
extracting, from the selected audiovisual content stream, data related to the audiovisual content stream, the extracted data including both the audio data that relates to the video data and metadata information for both the audio and video data of the received audiovisual content stream;
receiving an indication of a device to send the extracted audio data and metadata information to; and
sending, to the indicated device, the extracted audio data and metadata information to be output to a user.

14. The method of claim 13, wherein the audio data and metadata information have different distribution paths than a distribution path of the video data.

15. The method of claim 13, wherein the indicated device is one of a smartphone, a tablet, a personal computer, a smartwatch, an iPod, an iPad, and Google Glass.

16. The method of claim 13, wherein the metadata information is one of sports scores, closed-captioned text, program title, program synopsis and cast list.

17. The method of claim 13, wherein sending the received metadata information further includes:
converting closed-captioned text within the analyzed metadata to audio, and
sending, to the indicated device, the converted audio.

18. The method of claim 13, further comprising after receiving, from the audiovisual content provider, the audiovisual content stream:
determining whether a user has permission to access the selected audiovisual content stream;
if the user does not have permission to access the selected audiovisual content stream, offering a content subscription to the user to allow access to the selected audiovisual content stream.

19. The method of claim 18, wherein determining whether the user has permission to access the indicated audiovisual content stream further includes determining whether the user has a subscription to access the indicated audiovisual content stream.

20. The method of claim 18, wherein offering a content subscription to the user includes one of:
offering a pay-per-view content subscription to the user to allow access to only the selected audiovisual content stream, and
offering a general content subscription to the user to allow access to at least the selected audiovisual content stream.
